(19) United States
(12) Patent Application Publication
(10) Pub. No.: US 2023/0021924 A1
(43) Pub. Date: Jan. 26, 2023

(54) RADIAL CLAMP DEVICES FOR CLAMPING HOISTING GRIPS TO CABLES

(71) Applicant: CommScope Technologies LLC, Hickory, NC (US)

(72) Inventors: Ronald A. Vaccaro, Taylorsville, NC (US); Aviral Joshi, Chicago, IL (US)

(21) Appl. No.: 17/826,977

(22) Filed: May 27, 2022

Related U.S. Application Data
(60) Provisional application No. 63/224,480, filed on Jul. 22, 2021.

(51) Int. Cl. F16B 2/08; H02G 1/04

(52) U.S. Cl. CPC F16B 2/08; H02G 1/04

(57) ABSTRACT

Embodiments of radial clamps employed with hoisting grips for hoisting cables are disclosed herein.

### RELATED APPLICATION

The present application claims priority from and the benefit of U.S. Provisional Patent Application No. 63/224,480, filed Jul. 22, 2021, the disclosure of which is hereby incorporated herein by reference in full.

### FIELD OF THE INVENTION

The present invention relates to devices for assisting in the hoisting of cables.

### BACKGROUND

Currently, there a variety of hoisting grips that are used to hoist hunk and/or feed cables to the top of telecommunications towers and other telecommunication cell sites. Typically, hoisting grips are attached to one or more locations on the cable on the ground. A hoisting line is attached to the hoisting grip and used to raise the cable up the tower to the desired location for attachment to telecommunications equipment (e.g., a remote radio unit (RRU)). In some instances, the hoisting grips will be detached from the cable after the cable is raised; however, in other instances it may be undesirable or inconvenient to remove the hoisting grips, so they remain with the cable after installation and during operation.

Because cables may be heavy (particularly thick trunk or feeder cables), hoisting grips are typically relatively sturdy to grasp and retain the cable. One popular hoisting grip is a mesh or weblike sleeve that is configured much like a “Chinese finger trap,” in that the sleeve decreases in diameter (and therefore tightens on objects, like a cable, within its interior) when it is stretched axially (see FIG. 1B). Such hoisting grips are typically taped at one end to the cable to fix that end to the cable (see FIG. 1C), and a hoisting line is attached (often via a clevis pin) or the like) to the other end of the hoisting grip. Hoisting the hoisting line applies tension in the hoisting grip, which causes it to tighten on the cable during hoisting.

As might be expected, tape may be an inadequate medium for securing the lower end of the hoisting grip to the cable. However, the use of metal components to fix the hoisting grip (such as a metal oetiker clamp) near an antenna on cell sites can be a source of unwanted passive intermodulation (PIM) in the modern radio frequency (RF) environment. There may be a need for components for use with hoisting grips for cables used in telecommunications towers that reduce costs and allow for easy installation, while alleviating technical performance concerns, such as PIM.

### SUMMARY

As a first aspect, embodiments of the invention are directed to a radial clamp for a hoisting grip. The radial clamp comprises: an annular main ring with first and second opposed ends and an inner surface, wherein the first end includes a first fastening feature and the second end includes a second fastening feature that is configured to mate with the first fastening feature to enclose the main ring; and a plurality of hollow cushions mounted on or within the inner surface of the main ring.

As a second aspect, embodiments of the invention are directed to a radial clamp for a hoisting grip comprising an annular main ring formed of first and second generally semicircular sections, each of the first and second sections having first and second ends. The first end of the first section has a first fastening feature, the second end of the first section has a second fastening feature, the first end of the second section has a third fastening feature, and the second end of the second section has a fourth fastening feature. The first fastening feature is configured to mate with the third fastening feature, and the second fastening feature is configured to mate with the fourth fastening feature.

As a third aspect, embodiments of the invention are directed to a radial clamp for a hoisting grip comprising: an annular main ring with fastening features and an outer surface; and a cable hanger adapter mounted to the outer surface of the main ring, the cable hanger adapter having a mounting hole positioned radially outward of the outer surface of the main ring and sized and configured to receive a cable hanger.

### BRIEF DESCRIPTION OF THE FIGURES

FIG. 1A is a perspective view of an antenna tower with a hoisting line used to hoist a cable to a towertop antenna platform with a hoisting grip.

FIG. 1B is a greatly enlarged view of a conventional hoisting grip as may be used in FIG. 1A.

FIG. 1C is a greatly enlarged partial side view of the lower end of the hoisting grip of FIG. 1B showing tape used to secure the hoisting grip to the cable according to the prior art.

FIGS. 2A and 2B are plan and perspective views of a radial clamp to be used with a hoisting grip according to embodiments of the invention.

FIG. 3A is a plan view of radial clamp to be used with a hoisting grip according to alternative embodiments of the invention.

FIG. 3B is a partial plan view of a radial clamp to be used with a hoisting grip according to additional embodiments of the invention.

FIGS. 4A and 4B are plan and perspective views of a radial clamp to be used with a hoisting grip according to alternative embodiments of the invention.

FIG. 5 is a partial plan view of a radial clamp to be used with a hoisting grip according to further embodiments of the invention.

FIGS. 6 and 7 are plan and perspective views of a radial clamp to be used with a hoisting grip according to further embodiments of the invention.

FIGS. 8 and 9 are plan and perspective views of a radial clamp to be used with a hoisting grip and an attached cable hanger adapter according to embodiments of the invention.

FIGS. 10A and 10B are perspective views of cable hangers that may be employed in conjunction with the adapters of the hoisting grip of FIG. 8.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

It will be understood that, the terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprise” and “include” (and variants thereof), when used in this specification, specify the presence of stated operations, elements, and/or components, but do not preclude the presence or addition of one or more other operations, elements, components, and/or groups thereof. As used herein, the term “and/or” includes any and all combinations of one or more of the associated listed items. Like reference numbers signify like elements throughout the description of the figures.

The thicknesses of elements in the drawings may be exaggerated for the sake of clarity. Further, it will be understood that when an element is referred to as being “on,” “coupled to” or “connected to” another element, the element may be formed directly on, coupled to or connected to the other element, or there may be one or more intervening elements therebetween. In contrast, terms such as “directly on,” “directly coupled to” and “directly connected to,” when used herein, indicate that no intervening elements are present. Other words used to describe the relationship between elements should be interpreted in a like fashion (i.e., “between” versus “directly between”, “attached” versus “directly attached,” “adjacent” versus “directly adjacent”, etc.).

Terms such as “top,” “bottom,” “upper,” “lower,” “above,” “below,” and the like are used herein to describe the relationship of one element, layer or region to another element, layer or region as illustrated in the figures. It will be understood that these terms are intended to encompass different orientations of the device in addition to the orientation depicted in the figures.

It will be understood that, although the terms “first.” “second,” etc. may be used herein to describe various elements, these elements should not be limited by these terms. These terms are only used to distinguish one element from another. Thus, a first element could be termed a second element without departing from the teachings of the inventive concept.

It will also be appreciated that all exemplary embodiments disclosed herein can be combined in any way.

Finally, it is to be noted that, the above-described embodiments are merely for understanding the present invention but not constitute a limit on the protection scope of the present invention. For those skilled in the art, modifications may be made on the basis of the above-described embodiments, and these modifications do not depart from the protection scope of the present invention.

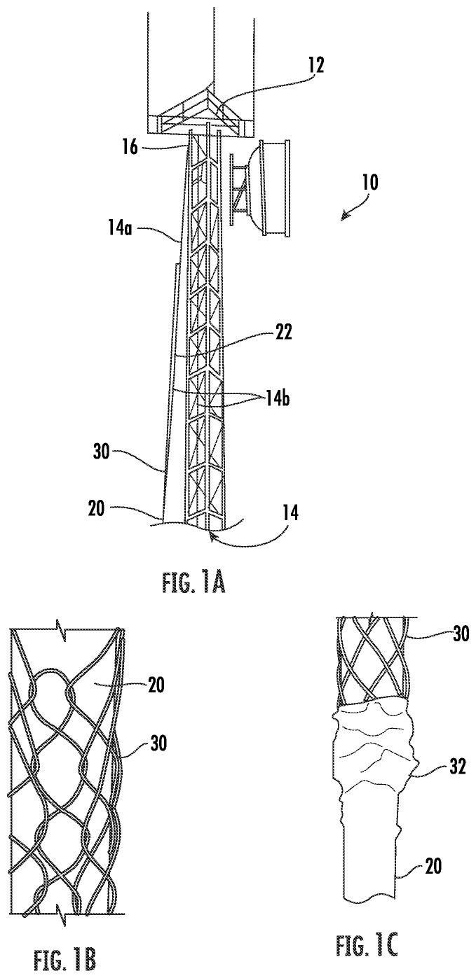

Referring now to the figures, a typical antenna tower is shown in FIG. 1 and designated at 10. The antenna tower 10 includes a platform 12 on which antennas (not shown) may be mounted; in addition, RRUs and other equipment (e.g., power distribution units) may be mounted on the platform 12. A cable 20 is shown being raised from the ground to the platform 12. A hoist line 14 is routed around a pulley 16 mounted just below the platform 12. A mesh-style hoisting grip 30 is attached to a portion 14a of the hoist line 14 and grasps the cable 20 (see FIG. 1B). As shown in FIG. 1C, in some prior embodiments, tape 32 secures the lower end of the hoisting grip 30 to the cable 20. A leader portion 22 of the cable is above the hoisting grip 30 and may be temporarily secured to the hoist line 14 with rope ties or the like. It can be envisioned that a technician on the ground pulls on a portion 14b of the hoist line 14, which, with the assistance of the pulley 16, causes the portion 14a and, in turn, the cable 20 to be raised toward the platform 12. Once the end of the cable 20 reaches the platform 14, it can be attached to the equipment mounted on the platform 12.

Although the rope ties may be loosened, in many instances the hoisting grip 30 may remain attached to the cable 20. If the hoisting grip 30 or its accompanying hardware were to include metallic components, the proximity of the hoisting grip 30 to the antennas may become a source of PIM.

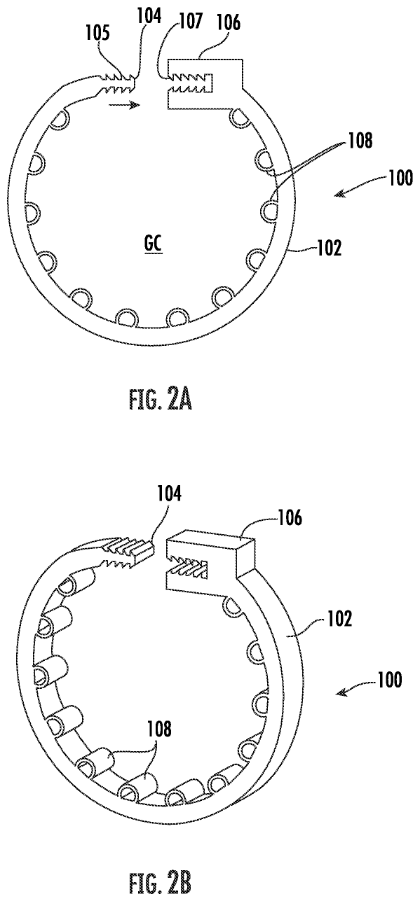

A radial clamp for a hoisting grip that may be capable of both firmly grasping the cable 20 and hoisting grip 30 and avoiding the generation of PIM according to embodiments of the present invention is shown in FIGS. 2A and 2B and is designated broadly at 100. The radial clamp 100 is generally annular, with an open main ring 102 that has a toothed projection 104 with teeth 105 at one end and a toothed receptacle 106 with teeth 107 at the opposite end. Hollow arcuate cushions 108 (that are generally semi-circular shaped) extend radially inwardly from the inner surface of the main ring 102. The radial clamp 100 thus has a grasping cavity GC.

The radial clamp 100 may be formed of a variety of materials, but is typically formed of a polymeric material, such as acetal or the like. A polymeric material can enable the radial clamp 100 to be used in any location near the antenna without creating PIM.

As can be envisioned from FIGS. 2A and 2B, the radial clamp 100 can be employed to grasp a cable and the lower end of a hoisting grip by separating the ends of the radial clamp 100, slipping a cable between the separated ends and into the grasping cavity GC, and drawing the ends together so that the projection 104 is received in the receptacle 106. The teeth 105 engage the teeth 107 to secure the ends together. The teeth 105, 107 may be configured to permit “one-way” movement (i.e., a “ratcheting” movement), such that the projection 104 can be drawn deeper into the receptacle 106, but cannot easily be drawn away from the receptacle 106. This arrangement can facilitate the tightening of the main ring 102 around the hoisting grip and, in turn, the cable.

In addition, the presence of the hollow arcuate cushions 108 can provide the radial clamp 100 with additional flexibility in grasping cables of different sizes. Because the cushions 108 are hollow, they can flex and “give” when engaging a cable and hoisting grip of a larger diameter than the diameter defined by the radially-innermost points of the cushions 108. A larger cable will tend to compress the cushions more than a smaller cable; in turn, the greater compression and deflection of the cushions 108 provides additional gripping strength on the cable.

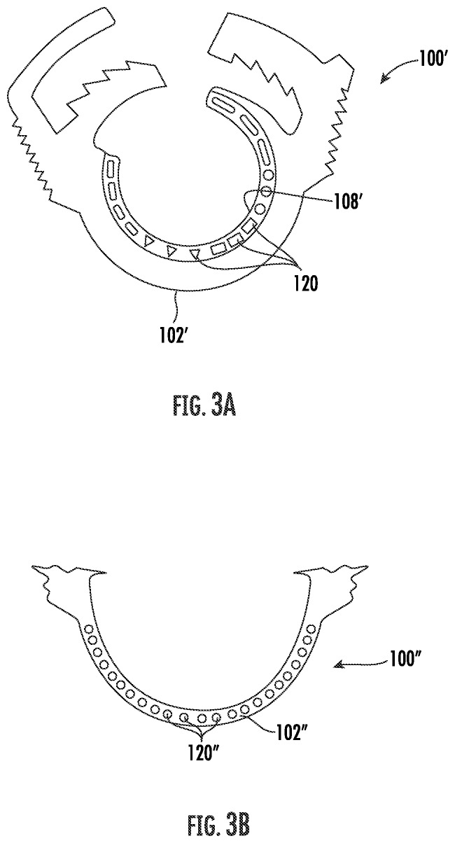

Those of skill in this art will appreciate that the radial clamp 100 may take different forms. For example, the cushions 108 may be more or fewer in number, may be positioned differently around the inner surface of the main ring 102, and/or may be of a different size and/or shape. Referring to FIG. 3A, a radial clamp 100′ has cushions 108′ that are formed within, rather than protecting from, the main ring 102′, due to the inclusion of apertures 120 below the inner surface of the main ring 102′. As shown schematically in FIG. 3A, the apertures 120 may be of any number of different shapes, such as round, square, oval, triangular, trapezoidal, etc. It can also be seen in FIG. 3B that a radial clamp 100″ with a thinner main ring 102″ and a series of closely spaced apertures 120″. It is envisioned that the presence of the apertures 120″ can enable the main ring 102″ to stretch in circumference to accommodate larger cables/hoisting grips as well as serving as cushions as described above. Other variations may also be suitable.

Also, although each of the projection 104 and receptacle 106 of the radial clamp 100 is shown with teeth 105, 107 on two opposed surfaces, in some embodiments the teeth may located be on only one surface of each of the projection and receptacle. In another example, the radial clamp may have two features that function as both projection and receptacle (see, e.g., jaws 104′, 106′ of radial clamp 100′ in FIG. 3A). Also, in some embodiments, the receptacle may have a bore therethrough, such that the projection can be pulled through the entire receptacle and project from the opposite end (somewhat akin to a “zip tie” style of band fastener). Other configurations of mating fastening features (e.g., a “split boss” that latches into a round bore or holes that serves as a receptacle) may also be employed.

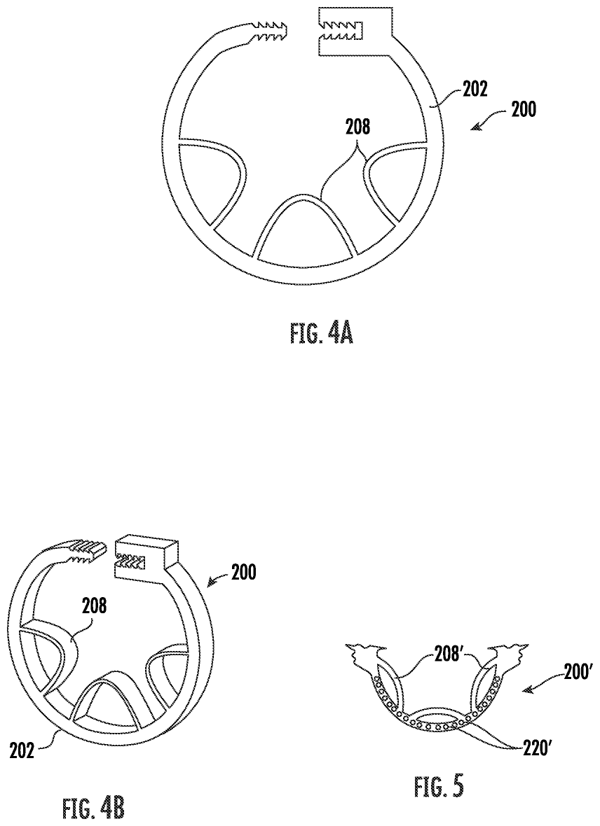

Referring now to FIGS. 4A and 4B, another radial clamp according to embodiments of the invention, designated broadly at 200, is shown therein. The radial clamp 200 is similar to the radial clamp 100, with exception that cushions 208 are larger and less numerous than the cushions 108, and are also shaped more like an “arch” than a semicircle. As such, the cushions 208 may provide the radial clamp 200 with the capacity to engage and grasp a wider variety of cable sizes than radial clamp 100.

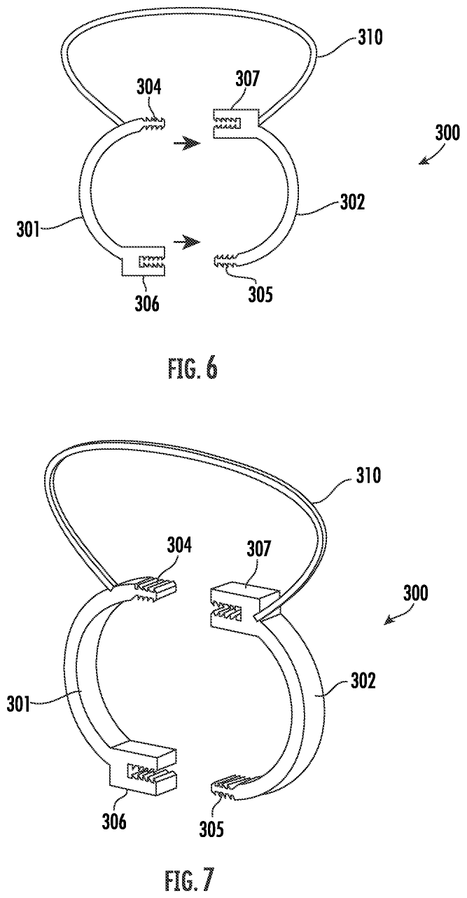

Those skilled in this art will appreciate that the cushions 208 may take other forms. For example, although the cushions 208 are illustrated as having a constant thickness, in some embodiments the cushions 208 may be thicker at portions adjacent the main ring 202 and thinner and radially inward portions. Such a configuration may improve the gripping force on a cable with a larger diameter, which would typically be heavier than a thinner cable. Further, as shown in FIG. 5, a radial clamp 200′ may have both cushions 208′ and apertures 220′ like those described above in connection with radial clamp 100″.

Referring now to FIGS. 6 and 7, another embodiment of a radial clamp according to embodiments of the invention, designated broadly at 300, is shown therein. The radial clamp 300 includes two generally semi-circular sections 301, 302. Each of the sections 301, 302 has a respective toothed projection 304, 305 on one end and a respective toothed receptacle 306, 307 at the opposite end. As can be seen in FIGS. 6 and 7, the sections 301, 302 are arranged so that the projection 304 is positioned to engage the receptacle 307, and the projection 305 is positioned to engage the receptable 306.

It can also be seen in FIGS. 6 and 7 that the sections 301, 302 are joined by a flexible tether 310. The tether 310 is attached at one end near the projection 304 and at its opposite end to the receptacle 307. The tether 310 should be of sufficient length to allow the sections 301, 302 to be easily handled and manipulated individually.

Like the radial clamp 100, the radial clamp 300 may be formed of a variety of materials, but is typically formed of a polymeric material, and therefore may be suitable for use in any location near the antenna without creating PIM.

In use, the radial clamp 300 can be positioned so that the sections 301, 302 are on opposite sides of a cable and hoisting grip to be grasped, and oriented so that the projections 304, 305 align with, respectively, the receptacles 306, 307. The sections 301, 302 can then be brought together so that the projection 304 is received in the receptacle 307 and the projection 305 is received in the receptacle 306, thereby forming a main ring with the sections 301, 302. As with the radial clamps 100, 200 above, the teeth of the projections 304, 305 and the receptacles 306, 307 may be configured so that they permit “one-way” relative movement. Further, variations to the fastening features discussed above may be equally applicable to the radial clamp 300.

It should also be noted that the tether 310 maintains the sections 301, 302 in proximity to each other, such that while handling one of the sections 301, 302, the other section 302, 301 remains nearby. As such, a technician employing the radial clamp 300 will always have both sections 301, 302 handy, without any risk of one of the sections 301, 302 being lost, dropped, mishandled, etc.

Those of skill in this art will appreciate that the radial clamp 300 may be modified in the manner described above for the radial clamp 100: as examples, the teeth of the projections and receptacles may be on one surface only, and the receptacles may include a bore that the projections extend completely through. Also, the sections 301, 302 may include cushions and apertures like those described in connection with the radial clamps 100, 200 above.

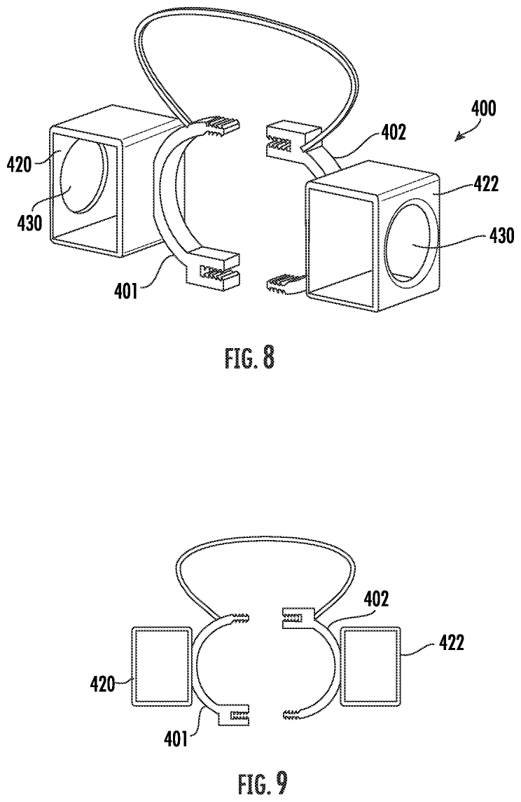

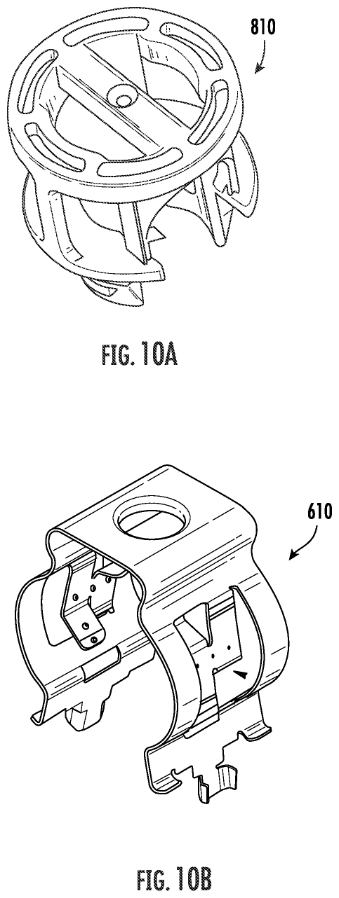

Referring now to FIGS. 8 and 9, another radial clamp, designated broadly at 400, is shown therein. The radial clamp 400 is similar to the radial clamp 300, but further includes a box-like cable hanger adapters 420, 422 attached to each of the sections 401, 402. Each of the adapters 420,422 includes a base 424, side walls 426, and a front wall 428 that includes a mounting hole 430. The mounting hole 430 is sized to receive a cable hanger 610 or 810 (see FIGS. 10A and 10B) for hanging cables. Typically, the mounting hole 430 has a nominal diameter of ¾ inch. Exemplary cable hangers are shown in U.S. Pat. Nos. 10,243,339 and 10,253,906 and U.S. Patent Application No. 63/168,442, the disclosures of each of which are hereby incorporated herein in full by reference.

Although in the illustrated embodiment only a single mounting hole is present in each adapter 420, 422, those of skill in this art will appreciate that adapters of other configurations may also be included. For example, a trapezoidal adapter having a configuration with mounting holes on three sides (such as is shown in U.S. Patent Publication No. 2021/0151971 to Vaccaro, the disclosure of which is hereby incorporated herein by reference in full), may be attached to one or both of the sections 401, 402. Also, the adapters may be employed with an open ring-style radial clamp like the radial clamps 100, 200 above. Other configurations may also be employed.

The invention being thus described, it will be apparent that the same may be varied in many ways. Such variations are not to be regarded as a departure from the spirit and scope of the invention, and all such modifications as would be obvious to one skilled in the art are to be included within the scope of the following claims.

That which is claimed is:

1. A radial clamp for a hoisting grip, comprising:
an annular main ring with first and second opposed ends and an inner surface, wherein the first end includes a first fastening feature and the second end includes a second fastening feature that is configured to mate with the first fastening feature to enclose the main ring; and
a plurality of hollow cushions mounted on or within the inner surface of the main ring.

2. The radial clamp defined in claim 1, wherein the first fastening feature is a toothed projection, and the second fastening feature is a toothed receptacle.

3. The radial clamp defined in claim 2, wherein the toothed projection and the toothed receptacle are configured for one-way movement.

4. The radial clamp defined in claim 1, wherein the hollow cushions are positioned within the inner surface of the main ring.

5. The radial clamp defined in claim 1, wherein the radial clamp is a unitary member formed of a polymeric material.

6. The radial clamp defined in claim 1, in combination with a hoisting grip and a cable, wherein the hoisting grip encircles the cable, and wherein the radial clamp is positioned to clamp the hoisting grip onto the cable.

7. A radial clamp for a hoisting grip, comprising:
an annular main ring formed of first and second generally semicircular sections, each of the first and second sections having first and second ends;
wherein the first end of the first section has a first fastening feature, the second end of the first section has a second fastening feature, the first end of the second section has a third fastening feature, and the second end of the second section has a fourth fastening feature; and
wherein the first fastening feature is configured to mate with the third fastening feature, and the second fastening feature is configured to mate with the fourth fastening feature.

8. The radial clamp defined in claim 7, wherein the first and fourth fastening features are substantially identical, and the second and third fastening features are substantially identical.

9. The radial clamp defined in claim 8, wherein the first and fourth fastening features are toothed projections, and the second and third fastening features are toothed receptacles.

10. The radial clamp defined in claim 9, wherein the toothed projections and the toothed receptacles are configured for one-way movement.

11. The radial clamp defined in claim 7, further comprising a flexible tether attached to the first and second sections.

12. The radial clamp defined in claim 7, wherein the radial clamp is a unitary member formed of a polymeric material.

13. The radial clamp defined in claim 7, in combination with a hoisting grip and a cable, wherein the hoisting grip encircles the cable, and wherein the radial clamp is positioned to clamp the hoisting grip onto the cable.

14. A radial clamp for a hoisting grip, comprising:
an annular main ring with fastening features and an outer surface; and
a cable hanger adapter mounted to the outer surface of the main ring, the cable hanger adapter having a mounting hole positioned radially outward of the outer surface of the main ring and sized and configured to receive a cable hanger.

15. The radial clamp defined in claim 14, wherein the annular main ring has first and second opposed ends, and wherein the first end includes a first fastening feature and the second end includes a second fastening feature that is configured to mate with the first fastening feature to enclose the main ring.

16. The radial clamp defined in claim 14, wherein the main ring is formed of first and second semicircular sections, each of the first and second sections having first and second ends:
wherein the first end of the first section has a first fastening feature, the second end of the first section has a second fastening feature, the first end of the second section has a third fastening feature, and the second end of the second section has a fourth fastening feature; and
wherein the first fastening feature is configured to mate with the third fastening feature, and the second fastening feature is configured to mate with the fourth fastening feature.

17. The radial clamp defined in claim 16, further comprising a flexible tether attached to the first and second sections.

18. The radial clamp defined in claim 17, wherein the radial clamp is a unitary member formed of a polymeric material.

19. The radial clamp defined in claim 14, in combination with a hoisting grip and a cable, wherein the hoisting grip encircles the cable, and wherein the radial clamp is positioned to clamp the hoisting grip onto the cable.

20. The radial clamp defined in claim 14, in combination with a cable hanger mounted in the mounting hole of the cable hanger adapter.
